(19) United States
(12) Patent Application Publication
(10) Pub. No.: US 2008/0158122 A1
(43) Pub. Date: Jul. 3, 2008

(54) Liquid crystal display and driving method thereof

(75) Inventors: Eddy Giing-Lii Chen, Miao-Li (TW); Sz-Hsiao Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/006,005

(22) Filed: Dec. 29, 2007

(30) Foreign Application Priority Data
Dec. 29, 2006 (TW) 95149708

(51) Int. Cl. G09G 3/36

(52) U.S. Cl. 345/89

(57) ABSTRACT

A liquid crystal display (1) includes a liquid crystal panel (10) including pixel units, a digital video card (14), a regulator (12) and a controller (13). The digital video card is configured for sequentially generating video signals. The regulator is configured for generating modulated video signals and generating a black-inserting signal. The controller is configured for receiveing the source video signals, the modulated video signals and the black-inserting signal, and selectively outputting the source video signals, the modulated video signals and the black-inserting signal to the pixel units during each frame.

### FIELD OF THE INVENTION

The present invention relates to a liquid crystal display (LCD) and a driving method of the liquid crystal display.

### GENERAL BACKGROUND

Because liquid crystal displays have the advantages of portability, low power consumption, and low radiation, they have been widely used in various portable information products such as notebooks, personal digital assistants (PDAs), video cameras, and the like. Furthermore, liquid crystal displays are considered by many to have the potential to completely replace cathode ray tube (CRT) monitors and televisions.

Referring to FIG. 3, a typical liquid crystal display 3 includes a data driving circuit 31, a gate driving circuit 32, a number n (where n is a natural number) of gate lines 321 that are parallel to each other and that extend along a first direction and a number k (where k is also a natural number) of data lines 311 that are parallel to each other and that extend along a second direction orthogonal to the first direction. The gate lines 321 are connected with the gate driving circuit 32. The data lines 311 are connected with the data driving circuit 31. The gate driving circuit 32 is configured for generating scanning signals and applying the scanning signals to the gate lines 321. The data driving circuit 31 is configured for generating gray-scale voltages and applying the gray-scale voltages to the data lines 311.

A smallest rectangular area made by every adjacent two gate lines 321 and every adjacent two data lines 311 is defined as a pixel unit (not labeled). Each pixel unit includes a thin film transistor (TFT) 35 provided in the vicinity of a respective point of intersection of the gate lines 321 and the data lines 311, a pixel electrode 36, a common electrode 37 opposite to the pixel electrode 36 and a liquid crystal layer (not labeled) sandwiched between the pixel electrode 36 and the common electrode 37. The thin film transistors 35 function as swiching elements.

Each thin film transistor 35 includes a gate electrode (not labeled), a source electrode (not labeled) and a drain electrode (not labeled). The gate electrode is connected with a corresponding gate line 321. The source electrode is connected with a corresponding signals line 311. The drain electrode is connected with a corresponding pixel electrode 36.

Referring to FIG. 4, G1-Gn represent scanning signals sequentially generated by the gate driving circuit 32, Vcom represents a predeternmined common voltage applied to the common electrode 37, and Vd represents gray-scale voltages generated by the data driving circuit 31.

When a scanning signals is applied to one of the gate lines 321, the thin film transistors 35 connected with the gate line 321 are activated. Then, the gray-scale voltages are applied to corresponding pixel electrodes 36 via the source electrode and drain electrode of the activated thin film transistor 35. Thus, electric fields are generated between the pixel electrodes 36 and the common electrode 37. The liquid crystal molecules in the electric fields are forced to twist in an angle according to intensities of the electric fields. Thus, the liquid crystal display 3 displays images with desired brightness.

However, when the liquid crystal display 3 displays motion pictures, a displayed image of one frame may remain in a viewer's visual perception as an afterimage, and this afterimage overlaps with the viewer's perception of the displayed image of a next frame. This residual image phenomenor impairs a display quality of the liquid crystal display 3.

Consequently, considerable research is being conducted to overcome this problem. Referring to FIG. 5, it is a timing chart illustrating a new driving method of the liquid crystal display 3, which is configured for mitigating or even eliminating the residual image phenomenor. G1-Gn represent scanning signals generated by the gate driving circuit 32. Vcom represents a common voltage applied to the common electrode 37. Vd represents gray-scale voltages applied to the pixel electrodes 36.

For brevity, the new driving method of the liquid crystal display 3 includes the following steps:

a. A frame is divided into a first sub-frame period “A” and a second sub-frame period “B”.

b. In the first sub-frame period “A”, the gate driving circuit 32 sequentially applies a plurality of first scanning signals to the gate lines 321. The first scanning signals activate the thin film transistors 35 connected with the gate lines 321.

c. When the gate lines 321 are scanned, the data driving circuit 31 outputs the gray-scale voltages Vd corresponding to the normal images to the pixel electrodes 36 via the data lines 311 and the activated thin film transistors 35, respectively.

d. In the second sub-frame period “B”, the gate driving circuit 32 sequentially applies a plurality of second scanning signals to the gate lines 321, and activates the thin film transistors 35 connected with the gate lines 321.

e. When the gate lines 321 are scanned, the data driving circuit 31 applies a plurality of black-inserting voltages corresponding to black images to the pixel electrodes 36 via the data lines 311 and the activated thin film transistors 35, respectively.

f. In a next frame, the above steps are repeated.

In a word, in the new driving method of the liquid crystal display 3, a viewer perceives normal images during the first sub-frame period “A”, and perceives black images during the second sub-frame period “B”. Thus, an afterimage of the image displayed in the first sub-frame period “A” is lost from the viewer's perception during the second sub-frame period “B”. This means that there is no overlap of the afterimage with a perceived image of the next frame. Thus the display quality of the liquid crystal display 3 is improved.

However, when the liquid crystal display 3 displays still images in a plurality of sequential frames, bright images and black images are displayed alternately, thus flickers are induced. When the liquid crystal display 3 displays the black images in the second sub-frame period, a brightness of the liquid crystal display 3 is low. Therefore the display quality of the liquid crystal display 3 is impaired.

What is needed, thereof, is a liquid crystal display that can overcome the above-described deficiencies. What is also needed, is a driving method of such liquid crystal display.

### SUMMARY

In one preferred embodiment, a liquid crystal display includes a liquid crystal panel including a plurality of pixel units, a digital video card, a regulator and a multi-selector. The digital video card is configured for sequentially generating a plurality of source video signals. The regulator is configured for generating a plurality of modulated video signals and generating a black-inserting signal. The multi-selector is configured for receiveing the source video signals, the modulated video signals and the black-inserting signal, and selectively outputting the source video signals, the modulated video signals and the black-inserting signal to the pixel units during each frame.

Other novel features, advantages and aspects will become more apparent from the following detailed description when taken in conjunction with the accompanying drawings.

### BRIEF DESCRIPTION OF THE DRAWINGS

FIG. 1 is essentially an abbreviated circuit diagram of a liquid crystal display according to an exemplary embodiment of the present invention, the liquid crystal display including a comparator.

FIG. 2 is an abbreviated diagram showing a process of operation of the comparator of FIG. 1.

FIG. 3 is essentially an abbreviated circuit diagram of a conventional liquid crystal display.

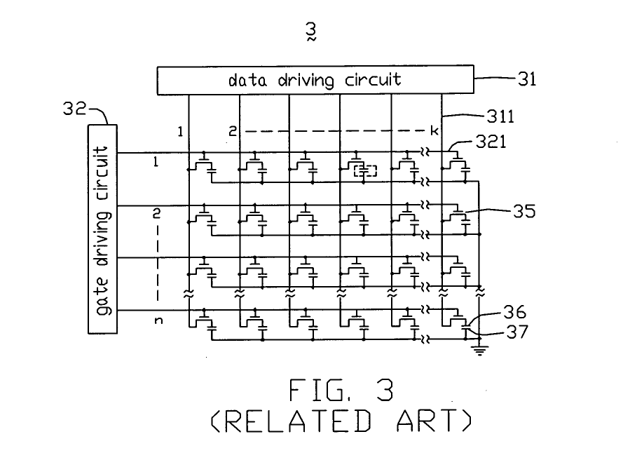

FIG. 4 is a timing chart illustrating a driving method of the liquid crystal display of FIG. 3.

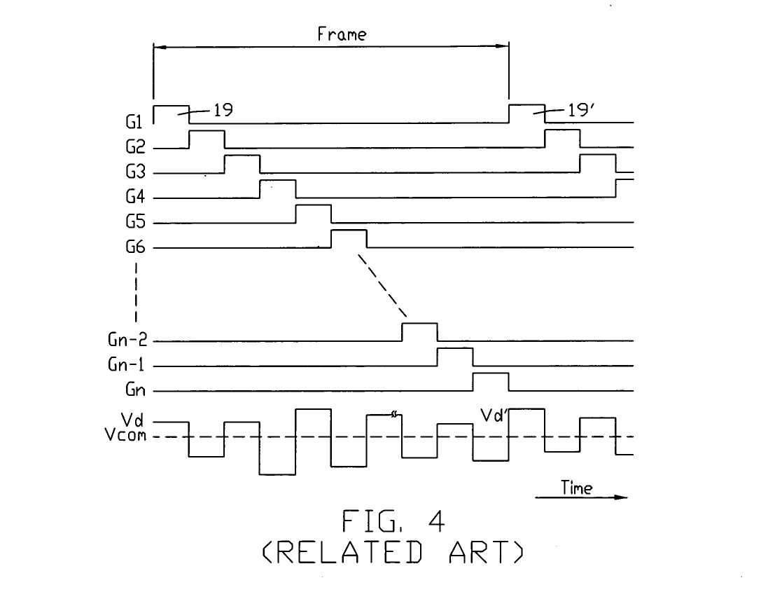

FIG. 5 is a timing chart illustrating another driving method of the liquid crystal display of FIG. 3.

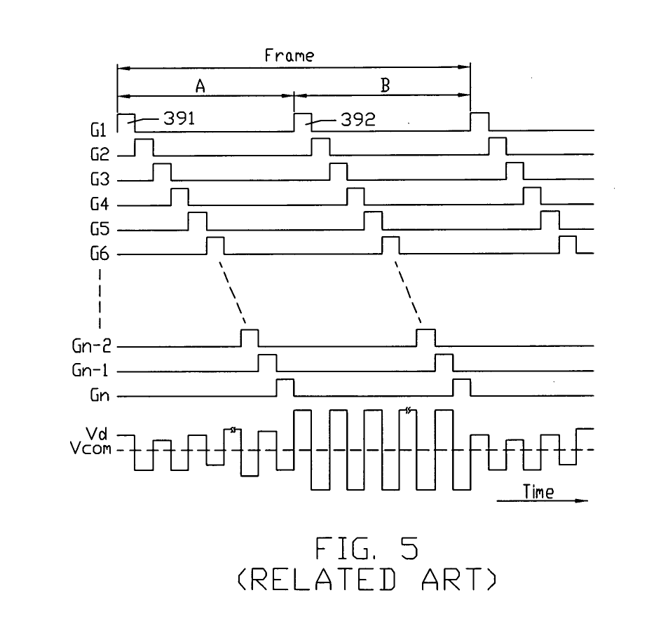

### DETAILED DESCRIPTION OF PREFERRED EMBODIMENTS

Reference will now be made to the drawings to describe the preferred embodiments in detail.

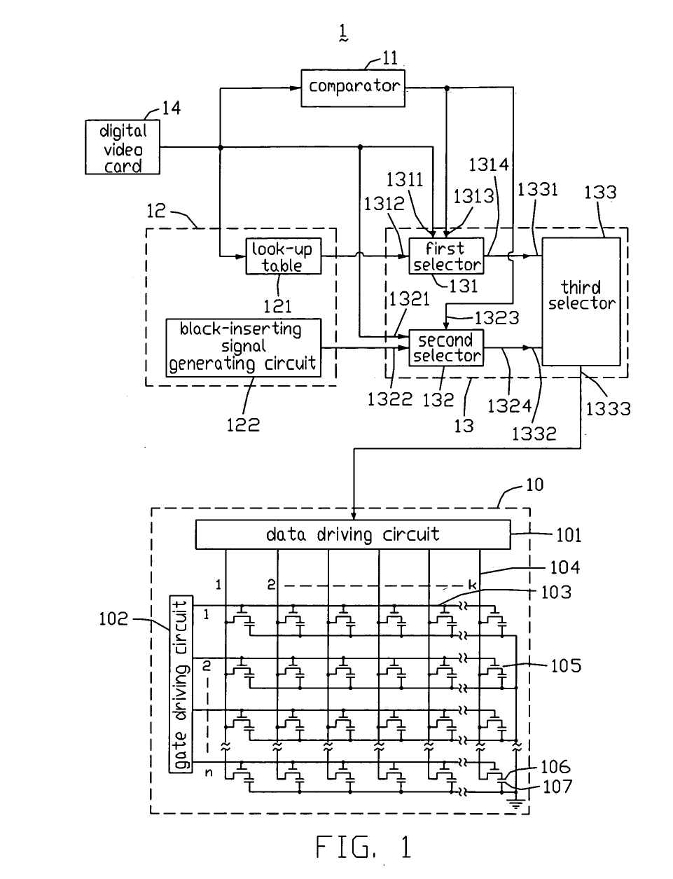

Referring to FIG. 1, a liquid crystal display 1 accoridng to a preferred embodiment of the present invention is shown. The liquid crystal display 1 includes a liquid crystal panel 10, a comparator 11, a regulator 12, a multi-selector 13 and a digital video card 14. The digital video card 14 is configured for sequentially generating source video signals corresponding to normal images and outputting the source video signals to the liquid crystal panel 10. The comparator 11 is configured for receiving the source video signals and sequentially generating a plurality of control signals. The regulator 12 is configured for sequentially receiving the source video signals and sequentially generating a plurality of modulated video signals correspondingly. The regulator 12 is also configured for generates black-inserting signal corresponding to a black image. The multi-selector 13 is configured for receiving the source video signals, the modulated video signals and the black-inserting signal, and selectively applying them to the liquid crystal panel 10 according to the control signals from the comparator 11. The liquid crystal panel 10 receives the signals from the multi-selector 13 and displays.

The liquid crystal panel 10 includes a data driving circuit 101, a gate driving circuit 102, a number n (where n is a natural number) of gate lines 103 that are parallel to each other and that extend along a first direction, a number k (where k is also a natural number) of data lines 104 that are parallel to each other and that extend along a second direction that is orthogonal to the first direction. The gate lines 103 are connected with the gate driving circuit 102. The data lines 104 are connected with the data driving circuit 101.

A smallest rectangular area made by every adjacent two gate lines 103 and every adjacent two data lines 104 is defined as a pixel unit (not labeled). Each pixel unit includes a thin film transistor 105 provided in the vicinity of a respective point of intersection of the gate lines 103 and the data lines 104, a pixel electrode 106, a common electrode 107 opposite to the pixel electrode 106 and a liquid crystal layer (not labeled) sandwiched between the pixel electrode 106 and the common electrode 107. The thin film transistors 105 function as switching elements.

Each thin film transistor 105 includes a gate electrode (not labeled), a source electrode (not labeled) and a drain electrode (not labeled). The gate electrode is connected with a respective gate line 103. The source electrode is connected with a respective data line 104. The drain electrode is connected with a respective pixel electrode 106.

The comparator 11 includes a memory (not shown) for storing source video signals of a previous frame. The stored source video signals are changed after a frame. The comparator 11 includes an input terminal (not labeled) coupled to the digital video card 14 and an output terminal (not labeled) coupled to the multi-selector 13.

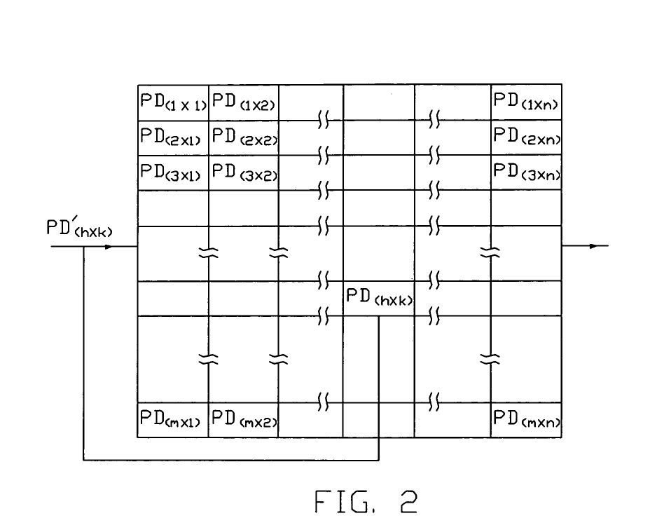

Referring to FIG. 2, the memory of the comparator 11 stores source video signals (PD_{1×1}, PD_{1×2}, PD_{1×3} . . . PD_{m×n}) of a previous frame. When the comparator 11 receives a source video signal PD′_{h×k} of the present frame, the comparator 11 compares the source video signals PD′_{h×k} with the source signal PD_{h×k} of the previous frame.

If a gray-scale of the source signal PD′_{h×k} is equal to a gray-scale of the source signal PD_{h×k}, the corresponding pixel unit displays a still image, thus the comparator 11 generates a first control signal. If a gray-scale of the source video signal PD′_{h×k} is not equal to a gray-scale of the source video signal PD_{h×k}, the corresponding pixel unit displays a motion image, thus the comparator 11 generates a second control signal.

The regulator 12 includes a look-up table 121 and a black-inserting signal generating circuit 122. The look-up table 121 includes an input terminal (not labeled) coupled to the digital video card 14 and an output terminal (not labeled) for applying the modulated video signals to the multi-selector 13. Gray-scales of the modulated video signals are greater than those of the source video signals. The black-inserting signal generating circuit 122 includes an output terminal (not labeled).

The multi-selector 13 includes a first selector 131, a second selector 132 and a third selector 133. The first selector 131 includes a first input terminal 1311 coupled to the digital video card 14, a second input terminal 1312 coupled to the look-up table 121, a third input terminal 1313 coupled to the output terminal of the comparator 11 and a first output terminal 1314.

The second selector 132 includes a fourth input terminal 1321 coupled to the digital video card 14, a fifth input terminal 1322 coupled to the black-inserting signal generating circuit 122, a sixth input terminal 1323 coupled to the comparator 11, and a second output terminal 1324.

The third selector 133 includes a seventh input terminal 1331 coupled to the first output terminal 1314 of the first selector 131, an eighth input terminal 1332 coupled to the second output terminal 1324 of the second selector 132, and a third output terminal 1333 coupled to the data driving circuit 101.

A driving method of the liquid crystal display 1 includes the following steps. First, a frame is divided into a first sub-frame period “A” and a second sub-frame period “B”.

Second, in the first sub-frame period “A”, the digital video card 14 sequentially generates a plurality of source video signals, and outputs the source video signals to the comparator 11, the look-up table 121, the first selector 131 and the second selector 132.

Third, the look-up table 121 sequentially receives the source video signals, and sequentially generates a plurality of corresponding modulated video signals to the first selector 131. The black-inserting signal generating circuit 122 generates a black-inserting signal, and applies the black-inserting signal to the second selector 132.

Fourth, the comparator 11 receives the source video signals, and compares the source video signals with those of a previous frame. Then, the comparator 11 generates the plurality of first control signals or the plurality of second control signal to both the first selector 131 and the second selector 132. If two gray-scales of a pixel unit in two continuous frames are equal to each other, the comparator 11 generates a first control signal. If two gray-scales of a pixel unit in two continuous frames are not equal to each other, the comparator 11 generates a second control signal.

Fifth, if the comparator 11 generates the first control signals, the first selector 131 outputs the source video signals to the third selector 133. If the comparator 11 generates the second control signals, the first selector 131 outputs the corresponding modulated video signals to the third selector 133.

Sixth, in the first sub-frame period “A”, the third selector 133 only receives video signals from the first selector 131, and outputs the video signals from the first selector 131 to the data driving circuit 101. That is, the third selector 133 outputs the source video signals or the modulated video signals to the data driving circuit 101. The data driving circuit 101 generates a plurality of gray-scale voltages and outputs the gray-scale voltages to the pixel units accordingly.

Seventh, scanning signals G1-Gn are generated by the gate driving circuit 102 and are applied to the gate lines 103. When the gate lines 103 are scanned, the thin film transistors 105 connected with the gate lines 103 are activated. The data driving circuit 101 applies the gray-scale voltages to the pixel electrodes 106 via the data lines 104 and the activated thin film transistors 105. The gray-scale voltages applied to the pixel electrodes 106 and a common voltage of the common electrode 107 control amounts of light transmission of the pixel units, thus images are displayed. Therefore, in the first sub-frame period “A”, the still images are displayed under a predetermined standard gray voltage for a predetermined gray scale, and the motion images are displayed under a greater gray voltage higher than that for a predetermined gray scale. Thus the illuminous flux is correspondingly higher.

Eighth, in the second sub-frame period “B”, the third selector 133 only receives video signals from the second selector 132 and outputs the video signals from the second selector 132 to the data driving circuit 101. If the comparator 11 generates the first control signals, the second selector 132 outputs the source video signals to the third selector 133. If the comparator 11 generates the second control signals, the second selector 132 outputs the black-inserting signal to the third selector 133.

Ninth, the data driving circuit 101 receives the source signals or the black-inserting signal, and generates a plurality of gray-scale voltages accordingly.

Tenth, the scanning signals G1-Gn are applied to the gate lines 103 one by one. When the gate lines 103 are scanned, the thin film transistor 105 connected with the gate lines 103 are activated. The data driving circuit 101 applies the gray-scale voltages to the pixel electrodes 106 via the data lines 104 and the activated thin film transistors 105. The gray-scale voltages applied to the pixel electrodes 106 and the common voltage of the common electrode 107 control amounts of light transmission of the pixel units, thus images are displayed. Therefore, in the second sub-frame period “B”, the still images are displayed under a predetermined standard gray voltage for a predetermined gray scale, and the pixel units displaying motion images display black images in the second sub-frame period.

Eleventh, the above steps are repeated.

Unlike conventional liquid crystal displays, the pixel units of the liquid crystal display 1 that display still images define a still area, and the pixel units of the liquid crystal display 1 that display motion images define a motion area. The still area displays the images with a predetermined amount of transmission of light beams in both the first sub-frame period “A” and the second sub-frame period “B”. The motion area displays images with a greater amount of transmission of light beams in the first sub-frame period “A”, and displays black images in the second sub-frame period “B”. Thus the motion area displays images with a predetermined amount of transmission of light beams in the frame. That is, both the still area and the motion area of the liquid crystal panel 10 display images with predetermined amounts of transmission of light beams in a frame. Furthermore, the still area does not display black images, thus no flickers are induced. Therefore, images displayed by the liquid crystal display panel 10 are clear and smooth.

In alternative embodiments, for example, the regulator 12 can be an integrate circuit or a microprocessor. In another embodiment, if a difference of gray-scale between a source video signals and a corresponding source video signals of a previous frame is equal to or less than N (where N is a natural number, and 1≦N≦5), the comparator generates a first control signal. If the difference of gray-scale between a source video signal and a corresponding source video signal of a previous frame is more than N, the comparator generates a second control signal.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display comprising:
a liquid crystal panel comprising a plurality of pixel units;
a digital video card configured for generating a plurality of source video signals;
a regulator configured for generating a plurality of modulated video signals and generating a black-inserting signal; and
a controller configured for receiveing the source video signals, the modulated video signals and the black-inserting signal, and selectively outputting the source video signals, the modulated video signals and the black-inserting signal to the pixel units during each frame.

2. The liquid crystal display as claimed in claim 1, wherein the controller outputs the source video signals and the modulated video signals to the pixel units in a first sub-frame period of a frame, and outputs the source video signals and the black-inserting signals to the pixel units in a second sub-frame period of the same frame.

3. The liquid crystal display as claimed in claim 2, wherein a gray-scale of a modulated video signal is greater than a gray-scale of a corresponding source video signal.

4. The liquid crystal display as claimed in claim 1, wherein the regulator comprises a black-inserting signal generating circuit for gengetating the black-inserting signal.

5. The liquid crystal display as claimed in claim 1, wherein the regulator comprises a look-up table for generating the modulated video signals.

6. The liquid crystal display as claimed in claim 1, wherein the regulator is an integrate circuit or a microprocessor.

7. The liquid crystal display as claimed in claim 1, further comprising a comparator for comparing the source video signals of present frame with corresponding source video signals of a previous frame, and generating a plurality of control signals.

8. The liquid crystal display as claimed in claim 7, wherein the control signals comprise a plurality of first control signals and a plurality of second control signals.

9. The liquid crystal display as claimed in claim 8, wherein the comparator is configured for generating the first control signal when a difference between two gray-scales corresponding to a source video signal and a source video signal of a previous frame is equal to or less than a natural number N, and generating the second control signal when a difference between two gray-scales corresponding to a source video signal and a source video signal of a previous frame is greater than the natural number N, the natural number ranging from 1 to 5.

10. The liquid crystal display as claimed in claim 8, wherein the controller comprises a first selector, a second selector and a third selector, each of the first selector and the second selector comprising an output terminal coupled to the third selector, the third selector comprising an output terminal coupled to the liquid crystal panel.

11. The liquid crystal display as claimed in claim 10, wherein the first selector is configured for outputting source video signals to the third selector when the comparator generates the first control signals, or outputting the modulated video signals to the third selector when the comparator generates the second control signals.

12. The liquid crystal display as claimed in claim 10, wherein the second selector is configured for outputting source video signals to the third selector when the comparator generates the first control signals, or outputting the black-inserting signal to the third selector when the comparator generates the second control signals.

13. The liquid crystal display as claimed in claim 10, wherein the third selector is configured for outputting signals received from the first selector to the liquid crystal panel in the first sub-frame period of a frame, and outputting signals received from the second selector to the liquid crystal panel in the second sub-frame of a frame.

14. A driving method of a liquid crystal display, the liquid crystal display comprising a digital video card, a regulator, a controller and a liquid crystal panel, the driving method comprising:
a. the digital video card generating a plurality of source video signals, and outputting the source video signals to the regulator and the multi-selector,
b. the regulator generating a plurality of modulated video signals corresponding to the source video signals and a black-inserting signal, and outputting the modulated video signals and the black-inserting signal to the multi-selector; and
c. the controller selectively outputting the source video signals, the modulated video signals and the black-inserting signal to the liquid crystal panel during each frame.

15. The driving method as claimed in claim 14, wherein each frame is divided into a first sub-frame period and a second sub-frame period, in the first sub-frame period, the multi-selector outputting the source video signals and the modulated video signals to the liquid crystal panel, in the second sub-frame period, the multi-selector outputting the source video signals and the black-inserting signal to the liquid crystal panel.

16. The driving method as claimed in claim 14, wherein the liquid crystal panel further comprises a comparator comparing each of the source video signals with a corresponding source video signal of a previous frame, and generating a control signal.

17. The driving method as claimed in claim 15, wherein the comparator generates a first control signal when a difference between two gray-scales corresponding to a source video signal and a source video signal of a previous frame is equal to or less than a natural number N, and generates a second control signal when a difference between two gray-scales corresponding to a source video signal and a source video signal of a previoius frame is more than the natural number N, the natural number ranging from 1 to 5.

18. The driving method as claimed in claim 17, wherein the controller outputs the source video signals to the liquid crystal panel in both the first sub-frame period and the second sub-frame period of a frame when the comparator generates first control signals.

19. The driving method as claimed in claim 17, wherein the controller outputs the modulated video signals to the liquid crystal panel in the first sub-frame period of a frame and outputs the black-inserting signal to the liquid crystal panel in the second sub-frame period of the frame when the comparator generates second control signals.
